(19) United States
(12) Patent Application Publication
(10) Pub. No.: US 2018/0232489 A1
(43) Pub. Date: Aug. 16, 2018

(54) ADDING ANNOTATIONS TO MEDICAL RECORDS

(71) Applicant: International Business Machines Corporation, Armonk, NY (US)

(72) Inventors: Patrick W. Fink, Charlotte, NC (US); Kristin E. McNeil, Charlotte, NC (US); Philip E. Parker, York, SC (US); David B. Werts, Charlotte, NC (US)

(21) Appl. No.: 15/433,131

(22) Filed: Feb. 15, 2017

(51) Int. Cl. G06F 19/00; G06F 17/24; G06F 17/27

(52) U.S. Cl. CPC G06F 19/322; G06F 19/3456; G06F 19/366; G06F 17/2785; G06F 17/241

(57) ABSTRACT

Medical data for transcription into a medical record is received. As the medical data is received, in real time: a computer-understandable meaning of text contained in the medical data can be identified by performing natural language processing on the text contained in the medical data; at least one medical transcription rule that applies to the medical data can be identified by processing the computer-understandable meaning of the text contained in the medical data; whether the medical data is incomplete can be determined by processing the computer-understandable meaning of text using the at least one medical transcription rule; and, responsive to determining that the medical data is incomplete, at least one annotation can be added to the medical record, the at least one annotation indicating data that is missing from the medical record and where in the medical record the data is missing.

### BACKGROUND

The present invention relates to data processing systems, and more specifically, to data processing systems used for medical transcription.

Medical transcription is the process of transcribing medical data into a medical record. The medical data can include physician dictated reports, procedures and notes, as well as other information, such as medical codes. Examples of document formats used for medical records include Consolidated Clinical Document Architecture (CCDA) documents, such as a Continuity of Care document (CCD), though other document formats are also used. CCDA documents typically are specified using extensible markup language (XML) based standards that specify the encoding, structure and semantics of medical data entered into the documents. The use of CCDA documents facilitates the exchange of patent medical data among medical providers (e.g., hospitals, physicians, etc.), and to insurance companies for claims billing.

Medical codes are used in a variety of different aspects of the medical profession. For example, medical codes are used to represent medical information, such as medical, surgical and diagnostic services, and claims billing information. The Current Procedural Terminology (CPT) code set is a set of medical codes maintained by the American Medical Association. The CPT code set is designed to communicate uniform information about medical services and procedures among physicians, coders, patients, accreditation organizations, and payers for various medical services. The CPT code set currently includes over ten thousand medical codes, and is updated annually. During the annual update, medical codes may be added, medical codes may be deleted, and descriptions of some medical codes may change.

### SUMMARY

A method includes receiving medical data for transcription into a medical record. The method also includes, as the medical data is received, in real time: identifying a computer-understandable meaning of text contained in the medical data by performing natural language processing on the text contained in the medical data; identifying at least one medical transcription rule that applies to the medical data by processing the computer-understandable meaning of the text contained in the medical data; determining, using a processor, whether the medical data is incomplete by processing the computer-understandable meaning of text using the at least one medical transcription rule; and, responsive to determining that the medical data is incomplete, adding at least one annotation to the medical record, the at least one annotation indicating data that is missing from the medical record and where in the medical record the data is missing.

A system includes a processor programmed to initiate executable operations. The executable operations include receiving medical data for transcription into a medical record. The executable operations also include, as the medical data is received, in real time: identifying a computer-understandable meaning of text contained in the medical data by performing natural language processing on the text contained in the medical data; identifying at least one medical transcription rule that applies to the medical data by processing the computer-understandable meaning of the text contained in the medical data; determining whether the medical data is incomplete by processing the computer-understandable meaning of text using the at least one medical transcription rule; and, responsive to determining that the medical data is incomplete, adding at least one annotation to the medical record, the at least one annotation indicating data that is missing from the medical record and where in the medical record the data is missing.

A computer program includes a computer readable storage medium having program code stored thereon. The program code is executable by a processor to perform a method. The method includes receiving medical data for transcription into a medical record. The method also includes, as the medical data is received, in real time: identifying, by the processor, a computer-understandable meaning of text contained in the medical data by performing natural language processing on the text contained in the medical data; identifying, by the processor, at least one medical transcription rule that applies to the medical data by processing the computer-understandable meaning of the text contained in the medical data; determining, by the processor, whether the medical data is incomplete by processing the computer-understandable meaning of text using the at least one medical transcription rule; and, responsive to determining that the medical data is incomplete, adding, by the processor, at least one annotation to the medical record, the at least one annotation indicating data that is missing from the medical record and where in the medical record the data is missing.

### BRIEF DESCRIPTION OF THE DRAWINGS

FIG. 1 is a block diagram illustrating an example of a data processing system that performs medical transcription.

FIG. 2 is a flow chart illustrating an example of a method of adding at least one annotation to a medical record.

FIG. 3 is a block diagram illustrating example architecture for the data processing system of FIG. 1.

### DETAILED DESCRIPTION

This disclosure relates to data processing systems, and more specifically, to data processing systems used for medical transcription. In accordance with the inventive arrangements disclosed herein, a processing system can receive medical data for transcription into a medical record. As the medical data is received, the processing system can, in real time, perform natural language processing (NLP) on the medical data to identify a computer-understandable meaning of text contained in the medical data. The processing system can identify one or more medical transcription rules that apply to the medical data by processing the computer-understandable meaning of the text. The processing system also can use the medical transcription rules to determine whether the medical data is incomplete. Responsive to determining that the medical data is incomplete, the data processing system can add at least one annotation to the medical record. The annotation can indicate data that is missing from the medical record and where in the medical record the data is missing. In one aspect, the data processing system can automatically determine the data that is missing, and the annotation can indicate such data.

Several definitions that apply throughout this document now will be presented.

As defined herein, the term “medical data” means data provided to a data processing system to be transcribed into a medical record of a patient.

As defined herein, the term “medical record” means documentation indicating a single patient's medical history and medical care.

As defined herein, the term “medical transcription rule” means a rule that indicates requirements for transcription of medical data into a medical record.

As defined herein, the term “annotation” means text or an identifier automatically added to a medical record by a data processing system based on a medical transcription rule.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

As defined herein, the term “patient” means a person (i.e., a human being) for whom medical services are provided or an animal for which medical services are provided.

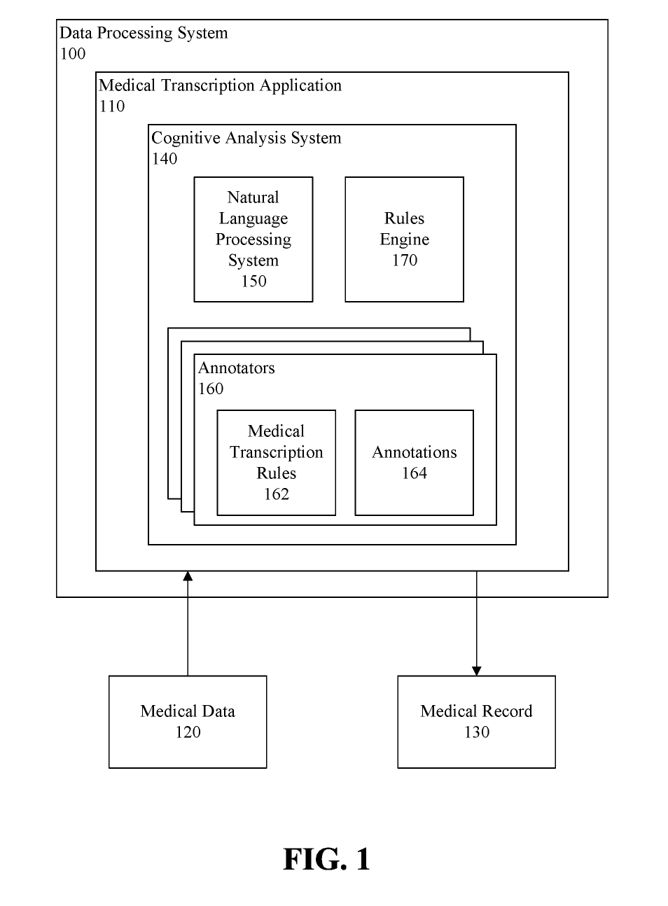

FIG. 1 is a block diagram illustrating an example of a data processing system 100. The data processing system 100 can include at least one processor and memory configured to execute a medical transcription application 110. The medical transcription application 110 can be configured to receive medical data 120 for transcription into a medical record 130. In one non-limiting arrangement, the medical record 130 can be a Consolidated Clinical Document Architecture (CCDA) document, for example a Continuity of Care document (CCD). The medical transcription application 110 can be a stand-alone application executing in a computing environment hosted by an operating system of the data processing system 100, or a plug-in software component that adds medical transcription capabilities to an another application. For example, the medical transcription application 110 can be implemented as a plug-in installed into a web browser, a word processor, a mobile application, or another suitable application.

The medical transcription application 110 can receive the medical data 120 as text. For example, a user can enter the medical data 120 using a keyboard and/or pointing device (e.g., a mouse and/or touchpad). The keyboard and/or pointing device can be coupled directly to the data processing system 100, or coupled to another data processing system that is communicatively linked to the data processing system 100 via one or more communication networks. For example, a user can interact with the medical transcription application 110 via a web browser, a mobile application, or another suitable type of application.

In another arrangement, the medical transcription application 110 can receive the medical data 120 as spoken utterances. For example, a user can speak the medical data 120 into an input audio transducer (not shown) coupled to the data processing system 100, or coupled to another data processing system that is communicatively linked to the data processing system 100. In such an arrangement, the medical transcription application 110 can implement speech recognition on the spoken utterances to convert the spoken utterances to text using a speech recognition engine (not shown). In another example, the medical transcription application 110 can receive a recording of spoken utterances and convert the spoken utterances to text using the speech recognition engine. Speech recognition is well known to those of ordinary skill in the art.

The medical transcription application 110 can include a cognitive analysis system 140. In one non-limiting example, the cognitive analysis system 140 can be implemented using an unstructured information management architecture (UIMA) Annotator system, such as IBM® Watson Explorer Content Analytics Studio. In another example, the cognitive analysis system 140 can be implemented using a declarative information extraction system, such as IBM® System T. In another example, the cognitive analysis system 140 can be implemented using Java® classes that follow rules to generate annotations.

In one arrangement, the cognitive analysis system 140 can be implemented as a plug-in software component that adds various features described herein to the medical transcription application 110. Accordingly, such features can be added to an existing medical transcription application 110 by installing the plugin into the medical transcription application 110. Nonetheless, the present arrangements are not limited in this regard. For example, the medical transcription application 110 can be coded to include, natively, the cognitive analysis system 140.

In another arrangement, the cognitive analysis system 140 can be executed on another data processing system to which the data processing system 100 is communicatively linked, for example via one or more communication networks. In illustration, the medical transcription application 110 can interface with the cognitive analysis system 140 via one or more communication network(s).

The cognitive analysis system 140 can include a natural language processing system 150. The natural language processing system 150 can implement natural language processing (NLP) and semantic analysis on information contained in the medical data 120, regardless of whether the medical data 120 is entered as text or entered as spoken utterances that are converted to text. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) (e.g., ISO/TC37/SC4) publishes standards for NLP. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. For example, semantic analysis can include performing semantic tokenization, which can tokenize text into linguistically significant and/or methodically useful phrases, sentences and paragraphs. UIMA, which is an industry standard for content analytics, may be used by the natural language processing system 150 to implement NLP and semantic analysis on the text of the medical data 120.

In one aspect, the natural language processing system 150 can communicatively link to, via one or more communication networks, one or more other data processing systems on which one or more other natural language processing systems are executed. Accordingly, the natural language processing system 150 can interface with the other natural language processing systems cooperatively to perform NLP on the text of the medical data 120.

The cognitive analysis system 140 also can include one or more annotators 160 and a rules engine 170. Each annotator 160 can include a plurality of medical transcription rules 162 and a plurality of annotations 164. The rules engine 170 can process tokenized phrases, sentences and/or paragraphs (i.e., identified as being linguistically significant and/or methodically useful) resulting from the NLP and semantic analysis using the medical transcription rules 162 to evaluate the phrases, sentences and/or paragraphs against the medical transcription rules 162. In this regard, the medical transcription rules 162 can be configured to identify concepts, orders of concepts and proximity of concepts to one another in the medical data 120. Further, each medical transcription rule 162 can be configured to, responsive to a portion of the medical data 120 (e.g., a phrase, sentence or paragraph) to which the medical transcription rule 162 applies not satisfying the medical transcription rule 162, identify one or more appropriate annotations 164.

The annotator 160 to which the medical transcription rule 162 is assigned can insert the selected annotation(s) 164 into an appropriate location in the medical record 130 being generated from the medical data 120. The appropriate location can be determined based on a document structure of the medical record 130. For example, the medical record 130 can be a document generated in accordance with the Continuity of Care document (CCD) specification, which is an extensible markup language (XML) based standard that specifies the encoding, structure and semantics of medical data entered into the document. Based on the specified XML structure for the document, the medical data 120 being added to the document, and the medical transcription rule 162, the annotator 160 can determine where to insert the selected annotation(s) 164.

The cognitive analysis system 140 can include a variety of annotators 160 for various aspects of medical data 120. For example, the cognitive analysis system 140 can include one or more annotators 160 pertaining to medications, one or more annotators 160 pertaining to vital signs, one or more annotators 160 pertaining to medical codes, one or more annotators 160 pertaining to laboratory tests, one or more annotators 160 pertaining to symptoms, illnesses, afflictions and/or diseases, and so on. In this regard, each annotator 160 can include a list of key words, acronyms, phrases and/or medical codes which indicate aspects of medical data 120 to which the annotator 160 pertains. Moreover, the list can identify concepts represented by the words, acronyms, phrases and/or medical codes, orders of the concepts and proximity of concepts to one another. Each medical transcription rule 162 can specify data that is required for completeness of a particular aspect of the medical data 120. Each annotation 164 can include text and/or symbols to be inserted into the medical record 130 where data is missing from the medical record 130.

In one non-limiting arrangement, lists of key words, acronyms, phrases and/or medical codes which indicate aspects of medical data 120 to which the annotators 160 pertain, the medical transcription rules 162 and the annotations 164 can be stored in one or more databases, for example in suitably configured data tables. The cognitive analysis system 140 can access the lists, medical transcription rules 162 and annotations 164 from the database(s).

The medical transcription application 110 can interface with the cognitive analysis system 140 to process medical data 120, in real time, as the medical transcription application 110 receives the medical data 120 and transcribes the medical data 120 into the medical record 130. In illustration, as text of the medical data 120 is received, the medical transcription application 110 can pass, in real time, the text to the cognitive analysis system 140. In real time, the natural language processing system 150 can process the text to tokenize the text (i.e., identify linguistically significant and/or methodically useful phrases, sentences and paragraphs in the text). Further, in real time, the cognitive analysis system 140 can process each token of text to identify at least one annotator 160 that pertains to the token of text. For example, the cognitive analysis system 140 can match words, acronyms, phrases and/or medical codes contained within the token of text to words, acronyms, phrases and/or medical codes assigned to the annotators 160. Further, the cognitive analysis system 140 can identify concepts, orders of concepts and proximity of concepts to one another in the tokenized text, and match such information to data assigned to the annotators 160 that indicates concepts, orders of concepts and proximity of concepts to one another.

The rules engine 170 can, in real time, process the token of text using the medical transcription rule(s) 162 assigned to the identified annotator(s) 160. Responsive to such processing indicating that the at least a portion of the medical data 120 is incomplete, the rules engine 170 can, in real time, based on the medical transcription rule(s) 162, identify one or more annotations 164 that indicate the data that is missing. Responsive to the rules engine 170 identifying such annotations 164, the annotator(s) 160 can insert, in real time, the identified annotations 164 into the medical record 130, in the appropriate location, for example within text transcribed from the medical data 120. Accordingly, a user viewing the medical record 130 while entering the medical data 120 can be notified immediately of information missing from the medical record 130.

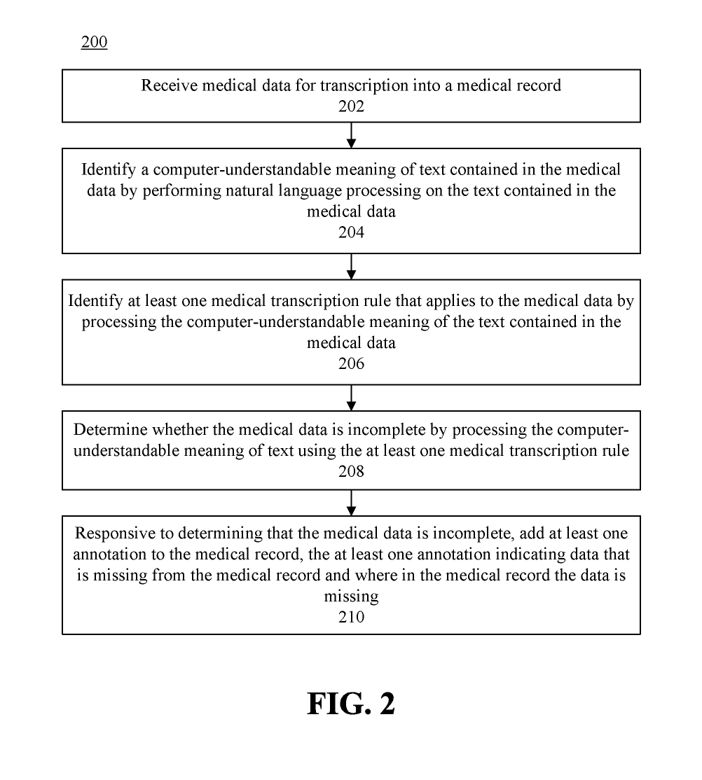

FIG. 2 is a flow chart illustrating an example of a method 200 of adding at least one annotation 164 to a medical record 130. At step 202, the medical transcription application 110 can receive medical data 120 for transcription into a medical record 130. The medical transcription application 110 can create a medical record 130 for the medical data 120, and add the medical data 120 to the medical record 130. In addition, the medical transcription application 110 can communicate the medical data 120 to the cognitive analysis system 140 for additional processing, as described in steps 204-210. Steps 204-210 can be performed, in real time, as the medical data 120 continues to be received by the medical transcription application 110 and the medical transcription application 110 continues to add the medical data 120 to the medical record 130.

At step 204, the cognitive analysis system 140 (e.g., the natural language processing system 150) can identify a computer-understandable meaning of text contained in the medical data 120 by performing natural language processing on the text contained in the medical data 120. At step 206, the cognitive analysis system 140 can identify at least one medical transcription rule 162 that applies to the medical data 120 by processing the computer-understandable meaning of the text contained in the medical data 120. For example, the cognitive analysis system 140 can identify at least one annotator 160 that pertains to the text, and identify at least one medical transcription rule 162 assigned to the identified annotator 160, as previously described. At step 208, the cognitive analysis system 140 (e.g., the rules engine 170) can determine whether the medical data is incomplete by processing the computer-understandable meaning of text using the at least one medical transcription rule. At step 210, Responsive to determining that the medical data is incomplete, the cognitive analysis system 140 (e.g., the annotator 160 to which the at least one medical transcription rule is assigned) can add at least one annotation 164 to the medical record 130, the at least one annotation 164 indicating data that is missing from the medical record 130 and where in the medical record 130 the data is missing.

The following examples represent various use cases in accordance with the present arrangements. In one example, assume that an applicable medical transcription rule 162 specifies a plurality of data items required to be presented with one another in the medical record 130 if at least one of the plurality of data items is included in the medical data 120. The medical data 120 can be determined to be incomplete responsive to the rules engine 170, processing the applicable medical transcription rule 162 rule, identifying that the text contained in the medical data 120 includes at least a first of the plurality of data items but does not include at least a second of the plurality of data items.

For instance, the medical transcription rule 162 can indicate that if a medication is prescribed, an appropriate medical code for the medication prescription is to be included in the medical record 130. Also, assume that the medical data 120 indicates a prescribed medication, but does not indicate a medical code for the medication prescription, or indicates and incorrect medical code. In such example, based on the medical transcription rule 162, the rules engine 170 can select an annotation 164 indicating that a medical code is required or the medical code provided in the medical data 120 is incorrect. The medical transcription rule 162 further can specify where the annotation 164 is to be placed in the medical record 130. Accordingly, the annotator 160 can place the annotations 164 in the medical record 130 at a location specified by the medical transcription rule 162. In one arrangement, the annotation 164 can indicate that the medical code is required for the medical record 130 to be complete, or indicate that the provided medical code is incorrect. In another arrangement, the medical transcription rule 162 can indicate the specific medical code for the prescribed medication. Based on the medical transcription rule 162, the rules engine 170 can identify an annotation 164 containing that medical code. Accordingly, the annotator 160 can place the annotation 164 containing the medical code in the medical record 130 at a location specified by the medical transcription rule 162. For example, the annotator 160 can place the annotation 164 containing the medical code in the location where the medical code should be, or replace the incorrect medical code with the annotation 164 containing the correct medical code. Of course, the above example can be applied to any other medical information that requires medical codes, and the present arrangements are not limited in this regard.

In another example, assume that an applicable medical transcription rule 162 specifies that prescriptions of medication require a dosage of the medication, a recommended route of administering the medication, and a recommended frequency at which a prescribed medication is to be administered. Also, assume that the medical data 120 includes a data item indicating a prescribed medication, but does not include data items indicating the dosage, recommended route, or recommended frequency. In such example, based on the medical transcription rule 162, the rules engine 170 can select an annotation 164 indicating that a dosage is required, select an annotation 164 indicating that a recommended route of administering the medication is required, and select an annotation 164 indicating that a recommended frequency at which the medication is to be taken is required. The medical transcription rule 162 further can specify that the annotations 164 are to be placed immediately after text in which the medication prescription is placed in the medical record 130. Accordingly, the annotator 160 can place the annotations 164 in the medical record 130 at the specified location. The annotations 164 can indicate that the dosage, route and recommended frequency at which the medication is to be taken are required for the medical record 130 to be complete.

In another example, assume that an applicable medical transcription rule 162 specifies that data items indicating laboratory tests performed are required to be presented in the medical record 130 with data items indicating a result of the laboratory tests. Also, assume that the medical data 120 includes a data item indicating a laboratory tests that was performed, but does not include a data item indicating a result of the laboratory test that was performed. In such example, based on the medical transcription rule 162, the rules engine 170 can select an annotation 164 indicating that at least one value indicating a result of the laboratory test is required. Again, the annotator 160 can place the annotations 164 in the medical record 130 at the location specified by the medical transcription rule 162.

In another example, assume that an applicable medical transcription rule 162 specifies a plurality of data items required to be presented with one another in the medical record 130 if at least one of the plurality of data items is included in the medical data 120. Further, assume that the applicable medical transcription rule 162 specifies, for at least one of the plurality of data items, an acceptable range for the data item. Responsive to identifying, based on the medical transcription rule 162, that the text contained in the medical data 120 includes at least a first of the plurality of data items that does not fit into the acceptable range for that data item, the rules engine 170 can determine the medical data 120 to be incomplete. Accordingly, the rules engine 170 can, based on the medical transcription rule 162, select an annotation 164 indicating that the data items does not fit into the acceptable range for that data item. The annotator 160 can insert the selected annotation 164 into the medical record 130 at a location specified by the medical transcription rule 162, for example immediately next to, above or below the data item.

In another example, assume that an applicable medical transcription rule 162 specifies at least one symptom and an illness, affliction or disease corresponding to the at least one symptom. Based on the medical transcription rule 162, the rules engine 170 can determine whether the medical data 120 contains text indicating the at least one symptom but does not include data indicating the illness, affliction or disease corresponding to the at least one symptom. If so, in response, the rules engine 170 can determine that the medical data 120 is incomplete. Accordingly, the rules engine 170 can, based on the medical transcription rule 162, select an annotation 164 indicating that data indicating the illness, affliction or disease is required. In another arrangement, the rules engine 170 can, based on the medical transcription rule 162, select an annotation 164 indicating the illness, affliction or disease corresponding to the at least one symptom. Regardless, the annotator 160 can insert the selected annotation 164 into the medical record 130 at a location specified by the medical transcription rule 162, for example immediately next to, above or below the text indicating the at least one symptom.

Continuing with the previous example, assume that the applicable medical transcription rule 162 also specifies a threshold duration of time for the at least one symptom. In such case, the rules engine 170 can select the annotation 164 indicating the illness, affliction or disease corresponding to the at least one symptom responsive to determining that the symptom does not persist for a period of time exceeding the threshold duration of time. If the symptom does persist for a period of time exceeding the threshold duration of time, the rules engine 170, based on the applicable medical transcription rule 162, can select an annotation 164 indicating such.

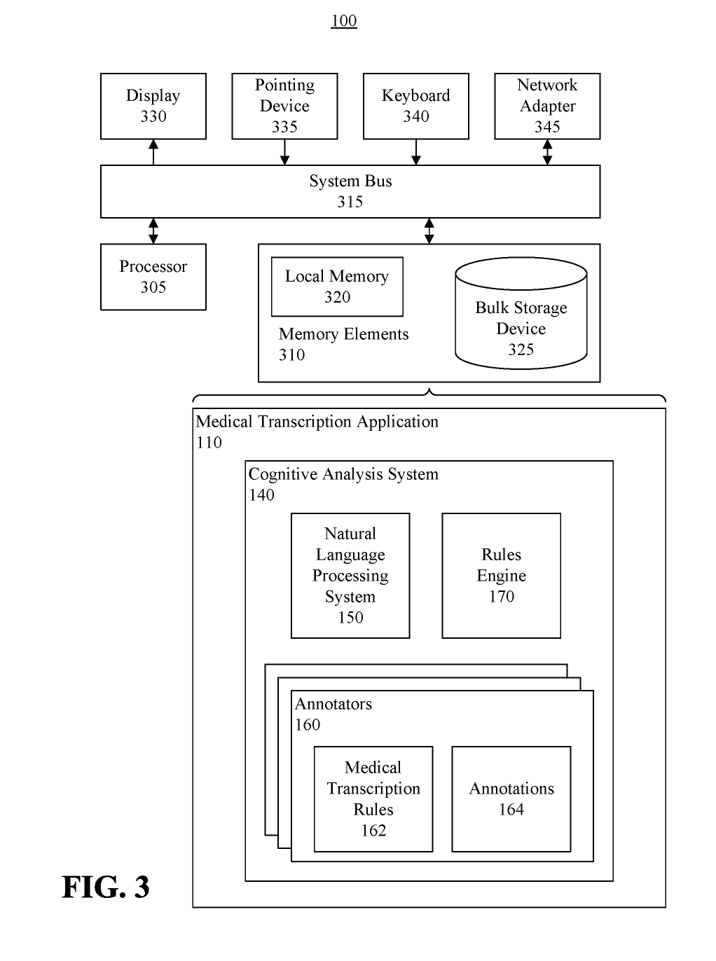

FIG. 3 is a block diagram illustrating example architecture for the data processing system 100 of FIG. 1. The data processing system 100 can include at least one processor 305 (e.g., a central processing unit) coupled to memory elements 310 through a system bus 315 or other suitable circuitry. As such, the data processing system 100 can store program code within the memory elements 310. The processor 305 can execute the program code accessed from the memory elements 310 via the system bus 315. It should be appreciated that the data processing system 100 can be implemented in the form of any system including a processor and memory that is capable of performing the functions and/or operations described within this specification. For example, the data processing system 100 can be implemented as a server, a plurality of communicatively linked servers, a workstation, a desktop computer, a mobile computer, a tablet computer, a laptop computer, a netbook computer, a smart phone, a personal digital assistant, a set-top box, and so on.

The memory elements 310 can include one or more physical memory devices such as, for example, local memory 320 and one or more bulk storage devices 325. Local memory 320 refers to random access memory (RAM) or other non-persistent memory device(s) generally used during actual execution of the program code. The bulk storage device(s) 325 can be implemented as a hard disk drive (HDD), solid state drive (SSD), or other persistent data storage device. The data processing system 100 also can include one or more cache memories (not shown) that provide temporary storage of at least some program code in order to reduce the number of times program code must be retrieved from the bulk storage device 325 during execution.

Input/output (I/O) devices such as a display 330, a pointing device 335 and, optionally, a keyboard 340 can be coupled to the data processing system 100. The I/O devices can be coupled to the data processing system 100 either directly or through intervening I/O controllers. For example, the display 330 can be coupled to the data processing system 100 via a graphics processing unit (GPU), which may be a component of the processor 305 or a discrete device. One or more network adapters 345 also can be coupled to data processing system 100 to enable the data processing system 100 to become coupled to other systems, computer systems, remote printers, and/or remote storage devices through intervening private or public networks. Modems, cable modems, transceivers, and Ethernet cards are examples of different types of network adapters 345 that can be used with the data processing system 100.

As pictured in FIG. 3, the memory elements 310 can store the components of the data processing system 100, namely the medical transcription application 110 and the cognitive analysis system 140, including the natural language processing system 150, the annotators 160, the medical transcription rules 162, the annotations 164 and the rules engine 170. Being implemented in the form of executable program code, these components of the medical transcription application 110 and the cognitive analysis system 140, including its components, can be executed by the data processing system 100 and, as such, can be considered part of the data processing system 100. Moreover, the medical transcription rules 162 and annotations 164 are functional data structures that impart functionality when employed as part of the data processing system 100.

The medical record 130 (shown in FIG. 1) can be output to, and stored within, the memory elements 310. As used herein, “outputting” and/or “output” can mean storing in the memory elements 310, for example, writing to a file stored in the memory elements 310, writing to the display 330 or other peripheral output device, playing audible notifications, sending or transmitting to another system, exporting, or similar operations.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving medical data for transcription into a medical record;
as the medical data is received, in real time:
identifying a computer-understandable meaning of text contained in the medical data by performing natural language processing on the text contained in the medical data;
identifying at least one medical transcription rule that applies to the medical data by processing the computer-understandable meaning of the text contained in the medical data;
determining, using a processor, whether the medical data is incomplete by processing the computer-understandable meaning of text using the at least one medical transcription rule; and
responsive to determining that the medical data is incomplete, adding at least one annotation to the medical record, the at least one annotation indicating data that is missing from the medical record and where in the medical record the data is missing.

2. The method of claim 1, wherein:
the at least one medical transcription rule specifies a plurality of data items required to be presented with one another in the medical record if at least one of the plurality of data items is included in the medical data; and
the medical data is determined to be incomplete responsive to identifying that the text contained in the medical data includes at least a first of the plurality of data items but does not include at least a second of the plurality of data items.

3. The method of claim 2, wherein:
the second of the plurality of data items is a medical code; and
the annotation is added to the medical record to replace an incorrect medical code provided in the medical data.

4. The method of claim 2, wherein:
at least the first of the plurality of data items indicates a prescribed medication; and
the second of the plurality of data items is a recommended frequency at which the prescribed medication is to be administered.

5. The method of claim 2, wherein:
at least the first of the plurality of data items indicates a laboratory test performed; and
the second of the plurality of data items is a value indicating a result of the laboratory test performed.

6. The method of claim 1, wherein:
the at least one medical transcription rule specifies a plurality of data items that are required to be presented with one another in the medical data if at least one of the plurality of data items is included in the medical data and, for at least one of the plurality of data items, the at least one medical transcription rule specifies an acceptable range for the data item; and
the medical data is determined to be incomplete responsive to identifying that the text contained in the medical data includes at least a first of the plurality of data items that does not fit into the acceptable range for that data item.

7. The method of claim 1, wherein:
the at least one medical transcription rule specifies at least one symptom and an illness, affliction or disease corresponding to the at least one symptom;
the medical data is determined to be incomplete responsive to identifying that the text contained in the medical data includes data indicating the at least one symptom but does not include data indicating the illness, affliction or disease corresponding to the at least one symptom; and
the annotation indicates the illness, affliction or disease corresponding to the at least one symptom.

8. The method of claim 1, wherein:
the at least one medical transcription rule specifies at least one symptom, a threshold duration of time for the at least one symptom, and an illness, affliction or disease corresponding to the at least one symptom if a duration of time for which the symptom persists does not exceed the threshold duration for the at least one symptom;
the medical data is determined to be incomplete responsive to identifying that the text contained in the medical data includes data indicating the at least one symptom but does not include data indicating the illness, affliction or disease corresponding to the at least one symptom; and
the annotation indicates the illness, affliction or disease corresponding to the at least one symptom responsive to determining that the symptom does not persist for a period of time exceeding the threshold duration of time.

9. A system, comprising:
a processor programmed to initiate executable operations comprising:
receiving medical data for transcription into a medical record;
as the medical data is received, in real time:
identifying a computer-understandable meaning of text contained in the medical data by performing natural language processing on the text contained in the medical data;
identifying at least one medical transcription rule that applies to the medical data by processing the computer-understandable meaning of the text contained in the medical data;
determining whether the medical data is incomplete by processing the computer-understandable meaning of text using the at least one medical transcription rule; and
responsive to determining that the medical data is incomplete, adding at least one annotation to the medical record, the at least one annotation indicating data that is missing from the medical record and where in the medical record the data is missing.

10. The system of claim 9, wherein:
the at least one medical transcription rule specifies a plurality of data items required to be presented with one another in the medical record if at least one of the plurality of data items is included in the medical data; and
the medical data is determined to be incomplete responsive to identifying that the text contained in the medical data includes at least a first of the plurality of data items but does not include at least a second of the plurality of data items.

11. The system of claim 10, wherein:
the second of the plurality of data items is a medical code; and
the annotation is added to the medical record to replace an incorrect medical code provided in the medical data.

12. The system of claim 10, wherein:
at least the first of the plurality of data items indicates a prescribed medication; and
the second of the plurality of data items is a recommended frequency at which the prescribed medication is to be administered.

13. The system of claim 10, wherein:
at least the first of the plurality of data items indicates a laboratory test performed; and
the second of the plurality of data items is a value indicating a result of the laboratory test performed.

14. The system of claim 9, wherein:
the at least one medical transcription rule specifies a plurality of data items that are required to be presented with one another in the medical data if at least one of the plurality of data items is included in the medical data and, for at least one of the plurality of data items, the at least one medical transcription rule specifies an acceptable range for the data item; and
the medical data is determined to be incomplete responsive to identifying that the text contained in the medical data includes at least a first of the plurality of data items that does not fit into the acceptable range for that data item.

15. The system of claim 9, wherein:
the at least one medical transcription rule specifies at least one symptom and an illness, affliction or disease corresponding to the at least one symptom;
the medical data is determined to be incomplete responsive to identifying that the text contained in the medical data includes data indicating the at least one symptom but does not include data indicating the illness, affliction or disease corresponding to the at least one symptom; and
the annotation indicates the illness, affliction or disease corresponding to the at least one symptom.

16. The system of claim 9, wherein:
the at least one medical transcription rule specifies at least one symptom, a threshold duration of time for the at least one symptom, and an illness, affliction or disease corresponding to the at least one symptom if a duration of time for which the symptom persists does not exceed the threshold duration for the at least one symptom;
the medical data is determined to be incomplete responsive to identifying that the text contained in the medical data includes data indicating the at least one symptom but does not include data indicating the illness, affliction or disease corresponding to the at least one symptom; and
the annotation indicates the illness, affliction or disease corresponding to the at least one symptom responsive to determining that the symptom does not persist for a period of time exceeding the threshold duration of time.

17. A computer program product comprising a computer readable storage medium having program code stored thereon, the program code executable by a processor to perform a method comprising:
receiving, by the processor, medical data for transcription into a medical record;
as the medical data is received, in real time:
identifying, by the processor, a computer-understandable meaning of text contained in the medical data by performing natural language processing on the text contained in the medical data;
identifying, by the processor, at least one medical transcription rule that applies to the medical data by processing the computer-understandable meaning of the text contained in the medical data;
determining, by the processor, whether the medical data is incomplete by processing the computer-understandable meaning of text using the at least one medical transcription rule; and
responsive to determining that the medical data is incomplete, adding, by the processor, at least one annotation to the medical record, the at least one annotation indicating data that is missing from the medical record and where in the medical record the data is missing.

18. The computer program product of claim 17, wherein:
the at least one medical transcription rule specifies a plurality of data items required to be presented with one another in the medical record if at least one of the plurality of data items is included in the medical data; and
the medical data is determined to be incomplete responsive to identifying that the text contained in the medical data includes at least a first of the plurality of data items but does not include at least a second of the plurality of data items.

19. The computer program product of claim 18, wherein:
the second of the plurality of data items is a medical code; and
the annotation is added to the medical record to replace an incorrect medical code provided in the medical data.

20. The computer program product of claim 18, wherein:
at least the first of the plurality of data items indicates a prescribed medication; and
the second of the plurality of data items is a recommended frequency at which the prescribed medication is to be administered.
